(19) United States
(12) Patent Application Publication
(10) Pub. No.: US 2024/0062636 A1
(43) Pub. Date: Feb. 22, 2024

(54) SYSTEM AND METHOD FOR IDENTIFYING A WEAPON, AND TRACKING AND GENERATING AN ALERT IN RESPONSE TO THE WEAPON IDENTIFICATION

(71) Applicant: Frank Barillas, Tulsa, OK (US)

(72) Inventor: Frank Barillas, Tulsa, OK (US)

(21) Appl. No.: 18/235,016

(22) Filed: Aug. 17, 2023

Related U.S. Application Data
(60) Provisional application No. 63/398,652, filed on Aug. 17, 2022.

(51) Int. Cl. G08B 13/196; H04N 7/18; H04N 23/23

(52) U.S. Cl. CPC G08B 13/19608; H04N 7/181; H04N 23/23; G08B 13/1966; G08B 13/1965; B64U 10/13

(57) ABSTRACT

System and method for identifying a weapon, and tracking and generating an alert in response to the weapon identification are disclosed. The system includes an image capturing unit installed at a structure. The image capturing unit includes an image sensor and an infrared sensor. The infrared sensor identifies weapons being carried by persons or vehicles in its field of view. Concurrently, the image sensor captures and records the images of the person and/or the vehicle. The image capturing unit notifies law enforcement officers of the person and/or the vehicle having the weapons. In one implementation, the image capturing unit connects to an unmanned aerial vehicle (UAV). The UAV deploys and tracks the location after the person and/or the vehicle moves away from the field of view of the image capturing unit. The UAV tracks the person and/or the vehicle until the law enforcement officers capture the person and/or the vehicle.

The present application claims the benefit of U.S. Provisional Application No. 63/398,652, filed Aug. 17, 2022; all of which is incorporated in its entity by reference herein.

### FIELD OF INVENTION

The present subject matter generally relates to security systems. More specifically, the present subject matter relates to a system and a method for identifying a weapon inside or outside of a structure such as a school, religious gathering, a large gathering, and tracking and generating an alert in response to the weapon identification.

### BACKGROUND OF INVENTION

It is known that there has been significant increase in the number of mass shootings, knife attacks, and suicide attacks in recent years in the United States and across the globe. The knife attacks, mass shootings, or suicide attacks have been carried out in schools, hospitals, religious gatherings, parades or sports venue where a large gathering of people take place. Typically, when a mass shooting or knife attack or a suicide attack occurs in a school or any other building, emergency personnel or law enforcement personnel are alerted of the incident. Generally, the emergency personnel or the law enforcement personnel are notified of the location and the type of incident that occurred to help the people within or outside the building. Additionally, the emergency personnel or the law enforcement personnel are notified to respond to the individuals causing the mass shooting or knife attack or a suicide attack. It takes considerable time for the emergency personnel or the law enforcement personnel to reach the location. This results in an increase of casualties or injuries to the people.

Several systems have been developed in the past that help to notify the emergency personnel or the law enforcement personnel prior to or after the occurrence of an incident such as the mass shooting or the knife attack or the suicide attack to minimise or prevent the casualties or injuries to the people. One such example is disclosed in a U.S. Pat. No. 8,630,820, Entitled “Methods and systems for threat assessment, safety management, and monitoring of individuals and groups” (“the '820 patent”). The '820 patent discloses methods and systems anticipating a potentially threatening or dangerous incident, and providing varying levels of response to a user. In an exemplary embodiment, the present invention provides varying levels of assistance to a user prior to, during, and after a threatening incident occurs. By providing assistance prior to a threatening incident occurring, the system may be able to thwart potential attacks, bodily harm, robberies, break-ins, and other criminal or dangerous activity. The assistance can be, for example, in the form of deterrents, alerting first responders to go to the scene, sending security personnel to the scene, remotely monitoring the scene, remotely interacting with the scene, providing information and advice to the user.

Another example is disclosed in a U.S. Pat. No. 10,586,109, entitled “Indoor gunshot detection with video analytics” (“the '109 patent”). The '109 patent discloses indoor gunshot detection performed using video analytics. Infrared and acoustic information are collected within an indoor environment using a gunshot sensor. A gunshot is detected, in the indoor environment, based on the infrared and the acoustic information. Video collection is engaged based on the detecting of the gunshot. The video collection is from a video stream. In embodiments, the video stream is a buffered stream. Video analytics are performed for tracking a suspected shooter of the gunshot using the video that is collected. The suspected shooter is identified based on the video analytics. In embodiments, an audio microphone is activated based on the detecting of the gunshot. The suspected shooter is tracked based on the audio microphone. A person of interest is tagged and tracked by an operator of the gunshot detection system. Direction of the gunshot can be determined relative to the gunshot sensor unit.

Another example is disclosed in a U.S. Pat. No. 9,886,833, entitled “System and method of automated gunshot emergency response system” (“the '833 patent”). The '833 patent discloses a threat sensing system having a plurality of threat sensing devices distributed throughout a school or facility, with each of the threat sensing devices comprising one or more acoustic sensors, one or more gas sensors, and a communication circuit or communication device configured to output sensor data to a system gateway. The system gateway is configured to receive and process the sensor data output from the threat sensing devices and determine whether the processed sensor data corresponds to one of a predetermined plurality of known threats (e.g., a gunshot) and, if so, to communicate the existence of the threat, the processed sensor information, and/or predetermined messaging information to one or more recipient devices (e.g., first responders, dispatchers).

Yet another example is disclosed in a U.S. Pat. No. 11,361,638, entitled “Gunshot detection sensors incorporated into building management devices” (“the '638 patent”). The '638 patent discloses a gunshot detection system that provides integration with building management systems installed in a common building. Distributed devices of the building management systems (e.g., light fixtures, smoke detectors, thermostats, exit signs) are positioned throughout the building, and gunshot sensor units of the gunshot detection system are incorporated with, attached to and/or combined with the building management distributed devices. The gunshot sensor units share a common housing with the distributed building management devices, attach to the devices via attachment mechanisms, and/or are incorporated into hybrid devices that include gunshot sensor and building management elements. The gunshot sensor units might comprise reflectors for collecting and focusing sound waves onto microphones of the gunshot sensor units. These reflectors could be existing parts of building management devices, or common housings for the gunshot sensor units and the building management devices, and/or parts of the gunshot sensor units independent of the building management devices.

Although the above discussed disclosures are useful in identifying a threat and notifying the emergency personnel or the law enforcement personnel prior to or after the occurrence of a mass shooting or a knife attack or a suicide attack, they have few limitations. For instance, the above discussed disclosures cannot determine the type of threat posed by individual(s) within the vicinity of a building such as school. Further, the above discussed disclosures are not capable of identifying the individual(s) who might be the cause of the threat. Furthermore, the above discussed disclosures cannot track the individual(s) who posed/caused the threat beyond a certain distance after they flee the location.

Therefore, there is a need for a system for identifying a weapon inside or outside of a structure such as a school, church, or large gathering, and tracking an individual who possessed the weapon and generating an alert in response to the weapon identification.

### SUMMARY

It is an object of the present subject matter to provide a system for identifying a weapon within or outside of a structure and that avoids the drawback of known techniques.

It is another object of the present subject matter to provide a system for identifying a weapon, and tracking and generating an alert in response to the weapon identification.

It is another object of the present subject matter to provide a system for detecting persons or vehicles having weapons and posing danger to personnel in structures such as schools, hospitals, office buildings, large gatherings, etc., in order to prevent mass shootings, knife attacks, etc. from taking place.

It is yet another object of the present subject matter to provide a system for recording images or video of the person or vehicle having the weapon from the moment of detection and notifying law enforcement officers of the danger posed by them.

In order to achieve one or more objects, the present subject matter provides a system for identifying a weapon, and tracking and generating an alert in response to the weapon identification. The system includes one or more image capturing units installed at the top or desired locations of a structure. The structure includes, but not limited to, a school, a religious building such as a church, hospital, office building, or a large gathering such as a music concert, sports venue, etc. The one or more image capturing units communicatively connects to a server. The server communicatively connects to a law enforcement device operated by law enforcement officers.

The image capturing unit includes an image sensor and an infrared sensor. The infrared sensor identifies weapons carried by persons or placed in vehicles in its field of view. The weapon includes, but not limited to, a gun, pocket knife, grenade, explosive device, etc. Upon identifying the weapon, the image sensor captures and records the images of the person and/or the vehicle. The server notifies the law enforcement officers of the person and/or the vehicle having the weapons. The image capturing unit is powered by a battery that gets charged by a solar panel.

In one implementation, the image capturing unit connects to an unmanned aerial vehicle (UAV). The UAV deploys and tracks the location after the person and/or the vehicle is away from the field of view of the image capturing unit. The UAV tracks the person and/or the vehicle for a predetermined time period or distance or until the law enforcement officers capture the person and/or the vehicle.

In one advantageous feature of the present subject matter, the system helps to detect weapons and the persons carrying the weapons inside or outside of the structure. Upon detecting the weapons, the system records the images or video corresponding to the events that occur afterwards. This helps to track the events that take place and also the people responsible for the tragic actions. The presently disclosed subject matter helps to prevent tragic actions from occurring at various structures such as schools, homes, businesses, etc. and improves safety.

In another advantageous feature of the present subject matter, the system is capable of capturing and tracking the persons standing at a place or even when moving at random speeds. As a result, the system starts recording as soon as the weapon is detected and tracks until the person carrying the weapon is captured by the law enforcement officers.

In another advantageous feature of the present subject matter, the system categorizes the level of threat into (three) different categories such as green, yellow and red colour codes depending on who is possessing the weapons. This helps in preventing generation of false alarms and only tracking of persons who are unrecognised or having unauthorised access to the structure.

In yet another advantageous feature of the present subject matter, the system utilises the infrared sensor for detecting the weapon such as a knife, gun or an explosive weapon such as a grenade, based on temperature differences between the metallic weapon and the background body temperature of the people or vehicle carrying the weapon. This helps to identify and track the people or vehicle in the darkness and/or extreme weather conditions. Further, the image capturing unit captures weapons carried in the body, backpacks, suitcases, clothing, vehicles, etc. at all times of the day.

In yet another advantageous feature of the present subject matter, the system enhances the safety and security of people to move around safely within or vicinity of the structure without having to worry about threats such as mass shootings, knife attacks, etc.

Features and advantages of the subject matter hereof will become more apparent in light of the following detailed description of selected embodiments, as illustrated in the accompanying FIGUREs. As will be realised, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present subject matter will become apparent from the following detailed description, taken in combination with the appended drawings, in which:

FIG. 1 illustrates an exemplary network communications system for identifying a weapon, and tracking and generating an alert in response to the weapon identification, in accordance with one embodiment of the present subject matter;

FIG. 2 illustrates an exemplary environment in which an image capturing unit installs at a structure, in accordance with one embodiment of the present subject matter;

FIG. 3 illustrates a diagrammatic representation of the image capturing unit, in accordance with one embodiment of the present subject matter;

FIG. 4 illustrates a diagrammatic representation of the server, in accordance with one embodiment of the present subject matter;

FIG. 5 illustrates an exemplary environment of identifying a threat or weapon being carried by an individual, in accordance with one embodiment of the subject matter;

FIG. 6 illustrates an exemplary environment of identifying an individual and/or a vehicle, in accordance with one embodiment of the subject matter;

FIG. 7 illustrates an exemplary environment of identifying the type of weapon and determining the level of threat, in accordance with one embodiment of the subject matter; and

FIG. 8 illustrates a method of identifying a weapon, and tracking and generating an alert in response to the weapon identification, in accordance with one embodiment of the subject matter.

It will be noted that throughout the appended drawings, like features are identified by like reference numerals.

### DETAILED DESCRIPTION OF THE EMBODIMENTS

Before the present features and working principle of a system for identifying a weapon, and tracking and generating an alert in response to the weapon identification is described, it is to be understood that this subject matter is not limited to the particular system as described, since it may vary within the specification indicated. Various features for identifying a weapon, and tracking and generating an alert in response to the weapon identification might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present subject matter describes a system and method for identifying a weapon, and tracking and generating an alert in response to the weapon identification. The system includes an image capturing unit installed at a structure. The image capturing unit includes an image sensor and an infrared sensor. The infrared sensor identifies a weapon carried by persons or vehicles in its field of view. Concurrently, the image sensor captures and records the images of the person and/or the vehicle. The image capturing unit notifies law enforcement officers of the person and/or the vehicle having the weapon. In one implementation, the image capturing unit connects to an unmanned aerial vehicle (UAV). The UAV deploys and tracks the location after the person and/or the vehicle is away from the field of view of the image capturing unit. The UAV tracks the person and/or the vehicle until the law enforcement officers capture the person and/or the vehicle.

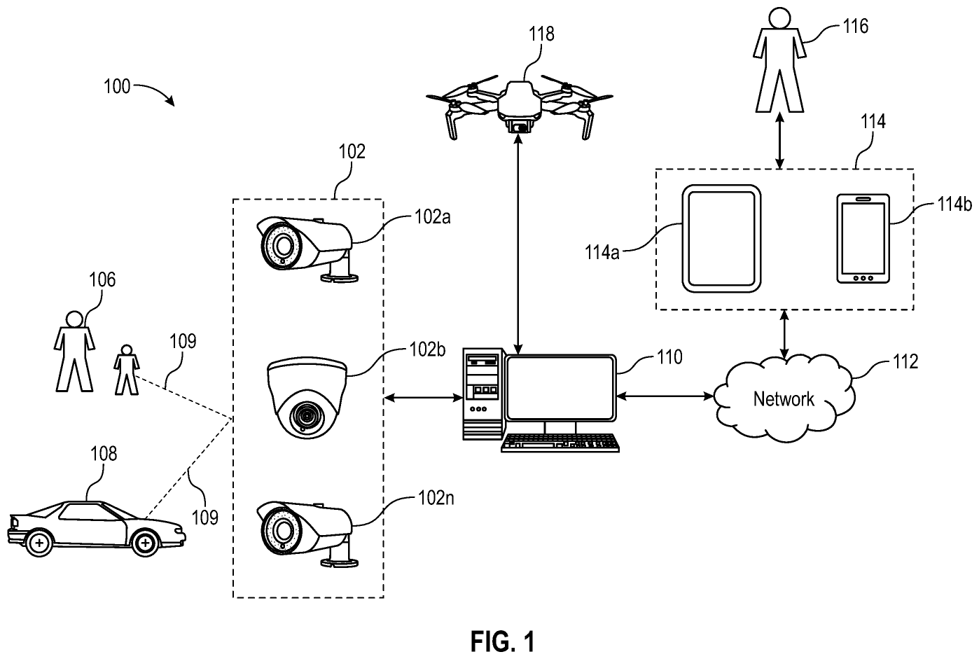

Various features and embodiments of the system for identifying a weapon, and tracking and generating an alert in response to the weapon identification are explained in conjunction with the description of FIGS. 1-8.

The present subject matter discloses a system for identifying a weapon, and tracking and generating an alert in response to the weapon identification. The system may be realised in a network communications system. FIG. 1 shows a high-level block diagram of an exemplary network communications system 100, in accordance with one embodiment of the present subject matter. For ease of reference, network communications system 100 is referred to as system 100 throughout the description. System 100 includes one or more image capturing units such as a first image capturing unit 102a, a second image capturing unit 102b . . . a n^{th} image capturing unit 102n, collectively referred as image capturing units 102 or simply image capturing unit 102. Image capturing unit 102 includes a camera, a closed-circuit television (CCTV) or an electronic device such as a mobile device, a laptop computer, a tablet computer, etc.

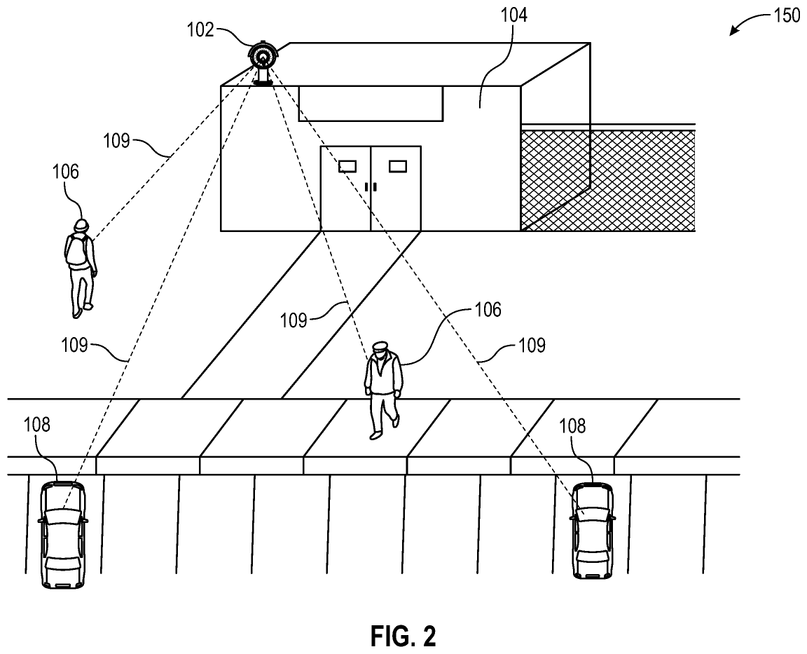

Image capturing unit 102 mounts at the top of a structure 104. Image capturing unit 102 is capable of rotating 360 degrees and capturing images in its field of view 109. FIG. 2 shows an environment 150 in which image capturing unit 102 mounts at the top of structure 104. An example of structure 104 includes, but not limited to, a school, a religious building such as a church, hospital, office building, or a large gathering such as a music concert, sports venue, etc. A person skilled in the art understands that any number of image capturing units 102 can be installed at the desired locations such as at top/roof the structure 104, surrounding walls or building, street posts, street lights or any other structure without departing from the scope of the present subject matter. Image capturing unit 102 captures images (still images or video, and/or infrared (IR) images of people 106 and/or vehicle 108 in its field of view 109. Image capturing unit 102 helps to detect weapons carried by people 106 sitting or standing or walking or running inside or outside of structure 104, and/or detect weapons present in vehicle 108 located inside/outside of structure 104.

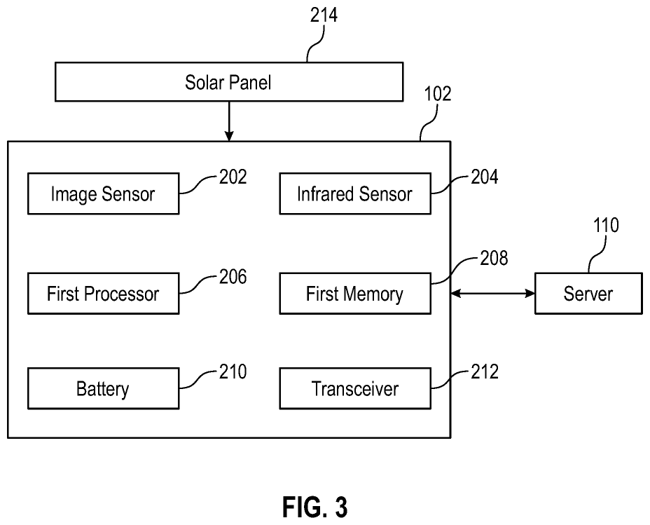

FIG. 3 shows a diagrammatic representation of the image capturing unit 102, in accordance with one embodiment of the present subject matter. Image capturing unit 102 includes an image sensor 202. Image sensor 202 is capable of capturing light that comes in through the lens to create a digital photo/image. As such, image sensor 202 captures still images or video of people 106 and vehicle 108 in its field of view 109.

Image capturing unit 102 includes an infrared (IR) sensor 204. IR sensor 204 is capable of utilizing a passive and non-intrusive scanning method like Infrared (IR) imaging technology to detect (concealed) weapons carried by people 106 or in vehicle 108 in its field of view 109. In one example, IR sensor 204 indicates a thermal camera capable of recording minute differences in the heat emitted by the objects i.e., people, weapon and vehicle and translating the information into visible images of the objects. IR sensor 204 utilises thermal contrast of the objects and provides vision on the objects thereby allowing it to identify and track the objects in the darkness and/or extreme weather conditions. In other words, IR sensor 204 detects a weapon (not shown) such as a knife, gun or an explosive weapon such as a grenade, based on temperature differences between the metallic weapon and the background body temperature of the people 106 or vehicle 108 carrying the weapon.

Image capturing unit 102 includes a first processor 206. First processor 206 receives the information from image sensor 202 and IR sensor 204 and processes the information. First processor 206 performs arithmetic and logic operations to identify weapons carried by people 106 or vehicle 108 from the images captured by image sensor 202 and IR sensor 204. First processor 206 processes the information and stores the information in a first memory 208. First memory 208 includes a volatile memory and/or a non-volatile memory. Preferably, first memory 208 stores instructions or software programs processed by first processor 206. In one example, first processor 206 records the information such as images captured by image sensor 202 and IR sensor 204 and instructs first memory 208 to store the information.

Further, image capturing unit 102 includes a battery 210. Battery 210 includes a rechargeable battery such as a Lithium-Ion (Li-ion) used for powering the electrical components of image capturing unit 102.

Image capturing unit 102 includes a transceiver 212. Transceiver 212 transmits or receives instructions over a network (e.g., network 112) utilising any one of a number of well-known transfer protocols.

In one example, image capturing unit 102 includes a solar panel 214. Solar panel 214 supplies required power to recharge battery 210.

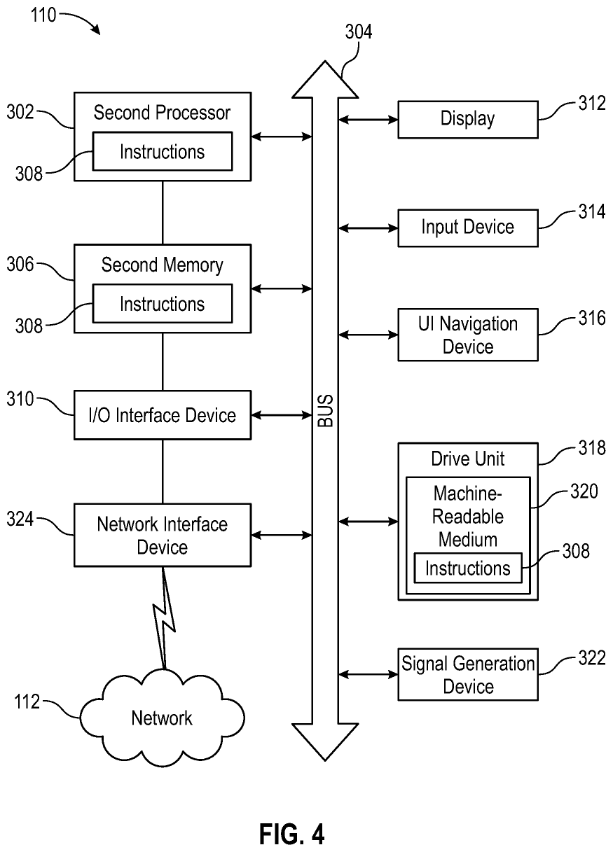

Referring to FIG. 1, image capturing unit 102 communicatively connects to a server 110. Server 110 indicates a computer or data centre operated by the management of structure 104 or by law enforcement officers 116. Server 110 situates inside or outside (remotely) of structure 104. FIG. 4 shows a diagrammatic representation of the server, in accordance with one embodiment of the present subject matter. Server 110 encompasses a second processor 302 (e.g., a central processing unit (CPU), a graphics processing unit (GPU), or both). Second processor 302 electrically couples by a data bus 304 to a second memory 306. Second memory 306 includes volatile memory and/or non-volatile memory. Preferably, second memory 306 stores instructions or software program 308 that interact with the other devices in image capturing unit 102 and/or law enforcement device 114 as described below. In one implementation, second processor 302 executes instructions 308 stored in second memory 306 in any suitable manner. In one implementation, second memory 306 stores digital data indicative of documents, files, programs, web pages, etc. retrieved from one of image capturing unit 102, law enforcement device 114 or an unmanned aerial vehicle (UAV) 118.

Server 110 further includes a first display 312 (e.g., a liquid crystal display (LCD) or a cathode ray tube (CRT)). Server 110 includes an input device (e.g., a keyboard) and/or touchscreen 314, a user interface (UI) navigation device 316 (e.g., a mouse), a drive unit 318, a signal generation device 322 (e.g., a speaker), and a network interface device 324.

Drive unit 318 includes a machine-readable medium 320 on which one or more sets of instructions and data structures (e.g., software 308) is stored. It should be understood that the term “machine-readable medium” includes a single medium or multiple medium (e.g., a centralised or distributed database, and/or associated caches and servers) that stores one or more sets of instructions. The term “machine-readable medium” also includes any medium that is capable of storing, encoding, or carrying a set of instructions for execution by the machine and that cause the machine to perform any one or more of the methodologies of the present subject matter, or that is capable of storing, encoding or carrying data structures utilised by or associated with such a set of instructions. The term “machine-readable medium” accordingly includes, but not be limited to, solid-state memories, optical and magnetic media, and carrier wave signals.

Instructions 308 reside, completely or at least partially, within second memory 306 and/or within second processor 302 during execution thereof by server 110. Network interface device 324 transmits or receives instructions 308 over a network 112 utilising any one of a number of well-known transfer protocols.

Network 112 includes a wireless network, a wired network or a combination thereof. Network 112 can be implemented as one of the different types of networks, such as intranet, local area network (LAN), wide area network (WAN), the internet, and the like. Network 112 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, network 112 includes a variety of network devices, including routers, bridges, servers, computing devices, storage devices, and the like.

Server 110 communicates with one or more government servers or law enforcement devices, say first law enforcement device 114a, and a second law enforcement device 114b, collectively referred to as law enforcement device 114. In one implementation, law enforcement device 114 indicates a server or database owned and operated by county, city, state, or federal government, or a law enforcement authority such as local police, federal police, department of justice, etc. Optionally, law enforcement device 114 indicates an electronic device such as a mobile device, a personal digital assistant, a laptop computer, a tablet computer, a desktop computer, etc. One or more law enforcement personnel operates law enforcement device 114. In the current embodiment, law enforcement officer 116 e.g., a police officer operates law enforcement device 114.

In one implementation, system 100 includes an unmanned aerial vehicle (UAV) 118. UAV 118 communicatively connects to server 110. Server 110 engages UAV 118 selectively to track or follow people 106 and/or vehicle 108. For example, server 110 engages UAV 118 to track vehicle 108 once vehicle 108 moves beyond field of view 109 of image capturing unit 102. Here, UAV 118 hovers in the air and tracks the location of vehicle 108 and helps to notify the location of vehicle 108 to server 110 and/or law enforcement device 114.

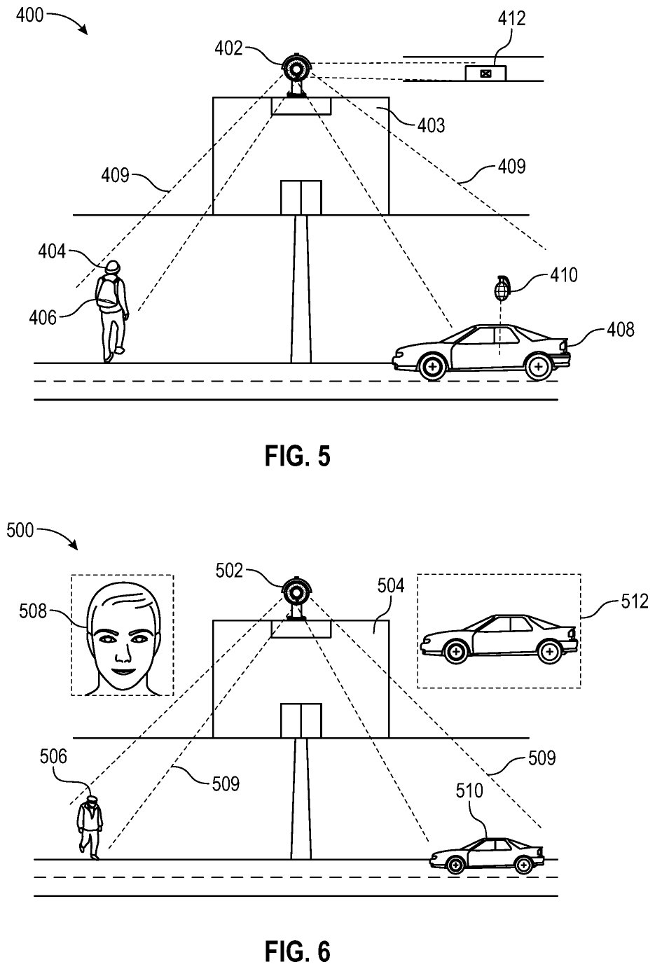

Now referring to FIGS. 5 through 7, operation of server 110 for identifying a weapon inside or outside of structure 104, and tracking and generating an alert in response to the weapon identification is explained. FIG. 5 shows an environment 400 in which image capturing unit 402 implements, in accordance with one exemplary embodiment of the present subject matter. Here, image capturing unit 402 installs at the top corner or at the middle of the roof of a structure 403. Structure 403 includes a school, a religious building such as a church, hospital, office building, or a large gathering such as a music concert, sports venue, etc. Image capturing unit 402 integrates all the components and operates similar to image capturing unit 102 as explained above. Image capturing unit 402 identifies people 404 and vehicles 408 in its field of view 409. In one example, image capturing unit 402 employs infrared (IR) sensor (not shown, similar to IR sensor 204) to capture metallic weapons carried by people 404 present in field of view 409. Metallic weapons include, but not limited to, a pocket knife, gun, rifle, grenade, or even a chemical weapon. In the present example, image capturing unit 402 employs the IR sensor and identifies people/person 404 carrying a weapon 406 such as a knife. Similarly, image capturing unit 402 employs IR sensor (not shown, similar to IR sensor 204) to capture metallic weapons carried in vehicle 408 present in field of view 409. In the present example, image capturing unit 402 employs the IR sensor and identifies that an explosive device 410 such as a grenade is present in vehicle 408.

After identifying weapon 406, 410 in its field of view 409, image capturing unit 402 records the images or video and stores them in the first memory (similar to first memory 208) or second memory 306. Further, image capturing unit 402 transmits a notification to a law enforcement device 412. The notification includes information such as type of weapon(s) 406, 410 detected, location of person 404 or vehicle 408, distance from image capturing unit 402 at which weapon 406, 410 has been detected, and speed at which person 404 or vehicle 408 is approaching or travelling away from structure 403, etc. In one implementation, image capturing unit 402 transmits the notification to law enforcement device 412 through server 110. It is preferable to transmit the notification to the nearest law enforcement personnel/police station/emergency response team. After receiving the notification, the law enforcement personnel deploy law enforcement officer 116 to the location to verify weapons 406, 410 being carried by any person 404 or weapon present in vehicle 408.

Consider a scenario in which image capturing unit 402 detects a weapon 410 in a moving vehicle 408 or detects a person 404 carrying the weapon 406 and flees away from field of view 409 image capturing unit 402 after detection. In such scenario, server 110 or image capturing unit 402 employs UAV 118. When not in use, UAV 118 stays in a standby mode. Upon receiving the notification of the person 404 or vehicle 408 going beyond field of view 409, UAV 118 takes flight and tracks the location of person 404 or vehicle 408 carrying weapon 406, 410. Optionally, UAV 118 includes a camera to capture the still images or live images of person 404 or vehicle 408 carrying weapon 406, 410. Further, UAV 118 transmits the still images or live images along with the location to law enforcement device 412 through server 110. This way, law enforcement officer(s) 116 are notified of the fleeing person 404 or vehicle 408 carrying weapons 406, 410. In one example, UAV 118 tracks person 404 or vehicle 408 for a predetermined distance, say 10 miles from structure 403. Optionally, UAV 118 tracks person 404 or vehicle 408 until law enforcement officer 116 captures person 404 or vehicle 408. In one example, the still images or live images captured by UAV 118 are displayed on display 312.

FIG. 6 shows an environment 500 in which image capturing unit 502 implements, in accordance with one exemplary embodiment of the present subject matter. Image capturing unit 502 implements at the top corner or at the middle of the roof of a structure 504. Image capturing unit 502 integrates all the components and operates similar to image capturing unit 102 as explained above. Image capturing unit 502 identifies people/person 506 and vehicles 510 carrying weapon (not shown) in its field of view 509. In order to identify the weapon, at first, image capturing unit 502 employs an Infrared (IR) sensor (not shown, similar to IR sensor 204). After identifying that a person 506 or vehicle 510 (i.e., person 506 travelling in vehicle 510) present in field of view 509 is carrying a weapon, image capturing unit 502 employs an image sensor (not shown, similar to image sensor 202) to capture the image of person 506 or vehicle 510. Subsequently, image capturing unit 502 or server 110 processes the image to run facial recognition 508 on person 506 to recognise the identity of person 506. Here, image capturing unit 502 or server 110 retrieves the facial recognition data from law enforcement device 114 to identify the person 506. Similarly, image capturing unit 502 or server 110 processes the image of vehicle 510 to identify vehicle identity or vehicle registration details 512. Here, image capturing unit 502 or server 110 retrieves the vehicle registration details 512 from law enforcement device 114 to identify vehicle 510 or owner of vehicle 510 or occupant of vehicle 510. In one example, the image of person 506 or vehicle 510 identified is displayed on display 312. After obtaining the details of person/people 506 and/or vehicle 510 carrying the weapon, image capturing unit 502 transmits a notification to law enforcement device 412 through server 110, as explained above.

Based on facial recognition and/or vehicle identification, image capturing unit 502 through server 110 may issue an alert. The alert is categorised into three categories, for example. For instance, if the weapon is non-lethal, then a green light is displayed on display 312 indicating the weapon does not pose any threat. Further, if it is determined that the person carrying the weapon is identified as a law enforcement officer or authorised personnel such as a parent, then a yellow light is displayed on display 312 indicating moderate or no threat. In one example, server 110 checks the serial number on the weapon to identify the weapon, make and type of weapon that is being used by the authorised personnel. Further, if it is determined that the person carrying the weapons is a non-authorised or unrecognised individual, then a red light is displayed on display 312. Here, the red light signifies potential threat posed by the person or vehicle having the weapon.

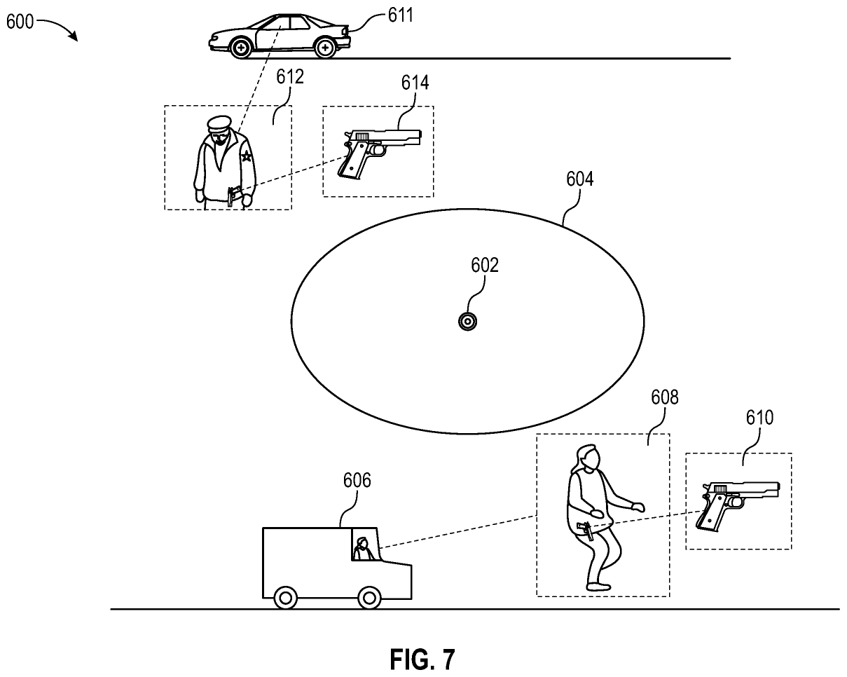

FIG. 7 shows an exemplary environment 600 in which image capturing unit 602 implements, in accordance with one exemplary embodiment of the present subject matter. Image capturing unit 602 implements at the top corner or at the middle of the roof of a structure 604. At first, image capturing unit 602 identifies vehicle 606. Further, image capturing unit 602 identifies person 608 carrying a weapon 610. As explained above, image capturing unit 602 identifies the identity of the vehicle 606, person 608 and the type of weapon 610. Similarly, image capturing unit 602 identifies vehicle 611. Further, image capturing unit 602 identifies person 612 carrying a weapon 614. Image capturing unit 602 captures the information and displays on display 312. In one example, image capturing unit 602 captures images of person 608 involved in altercations and/or bullying. Once image capturing unit 602 captures the images, the school authorities are alerted to prevent the altercations and/or bullying.

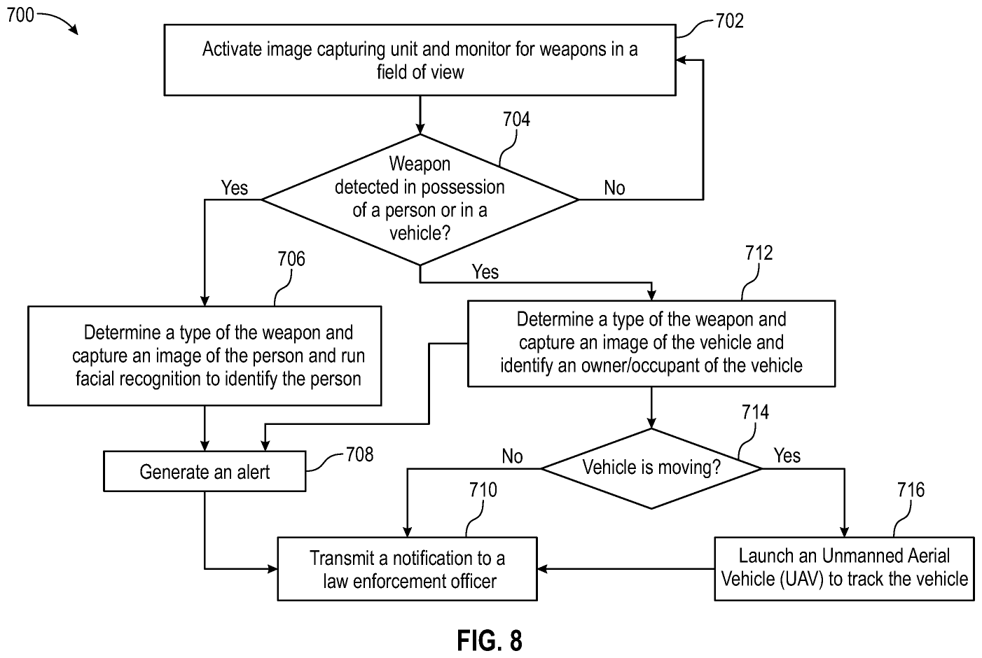

FIG. 8 illustrates method 700 of identifying a weapon, and tracking and generating an alert in response to the weapon identification, in accordance with one exemplary embodiment of the present subject matter. The order in which method 700 is described should not be construed as a limitation, and any number of the described method blocks can be combined in any order to implement method 700 or alternate methods. Additionally, individual blocks may be deleted from method 700 without departing from the spirit and scope of the subject matter described herein. Furthermore, method 700 can be implemented in any suitable hardware, software, firmware, or combination thereof. However, for ease of explanation, in the embodiments described below, method 700 may be implemented using the above-described server 110.

At first, server 110 activates image capturing unit 102, 402, 502, 602, as shown at step 702. After activating, image capturing unit 102, 402, 502, 602 monitors for presence of weapons in its field of view. Here, image capturing unit 102, 402, 502, 602 employs IR sensor 204 to detect presence of weapons in its field of view. At step 704, server 110 checks whether the weapon is detected in the field of view of image capturing unit 102. If image capturing unit 102 does not detect the weapon, then method 700 moves back to step 702. If image capturing unit 102 detects a weapon at step 704, then the method moves to step 706 or step 712. Specifically, if image capturing unit 102 detects that a person is in possession of the weapon, then method 700 moves to step 706. If the image capturing unit 102 detects that the weapon is in a vehicle, then method 700 moves to step 712.

At step 706, server 110 employs IR sensor 204 to determine a type of the weapon. Further, server 110 employs image sensor 202 to capture an image of the person possessing the weapon and run facial recognition to identify the person. After identifying the person and the weapon, server 110 generates an alert, as shown at step 708. The alert includes, but not limited to, generating an audio alert/siren to notify of the danger/threat to people within or outside of a structure, closing/shutting off the windows/doors of the structure, etc. In one example, server 110 generates the alert to indicate the level of threat such as green, yellow and red colour codes depending on who is possessing the weapons. In another example, the alert includes a route map, say on Google Maps™ to help people in the structure to reach a safe location during an emergency situation. Optionally, server 110 integrates all the laws and identifies if the people in the field of view has broken any laws. If server 110 identifies any person breaking the law, then server 110 identifies the person and transmits a notification to a law enforcement officer 116.

In another embodiment, server 110 employs image sensor 202 to determine the number of unique persons present within or outside structure 104 at any given point of time. This allows to count the number of people who entered structure 104 and number of people who are not present near structure 104. Further, image sensor 202 helps to identify any situation say, bullying that occurs within or outside structure 104. Optionally, image sensor 202 identifies any person suffering from bodily harm, depressed state, anxiety, etc. Based on the number of people present and the behaviour (such as mood, bodily harm, state of health, depressed state, anxiety), server 110 can notify the student, parent or even law enforcement officer 116.

Optionally, server 110 employs image sensor 202 to detect presence of animals including, but not limited to, pets, bears, snakes and the like. This helps to prevent injury or casualty due to unexpected entry of animals within or outside structure 104.

Further, server 110 transmits the notification to a law enforcement officer 116 i.e., on law enforcement device 114, as shown at step 710. The notification includes, but not limited to, the image of the person carrying the weapon, the type of weapon, location, etc. The notification is transmitted to alert the law enforcement officer 116 of the threat posed by the person or the vehicle having the weapon.

As specified above, if the image capturing unit 102 detects that the weapon is in the vehicle, then method 700 moves to step 712. At step 712, server 110 employs IR sensor 204 to determine a type of the weapon present in the vehicle. Further, server 110 employs image sensor 202 to capture an image of the vehicle and/or person possessing the weapon and run facial recognition or vehicle identification to identify the person/vehicle. After identifying the person, vehicle and the weapon, server 110 generates an alert, as shown at step 708. The alert includes, but not limited to, generating an audio alert/siren to notify of the danger/threat to people within or outside of a structure, closing/shutting off the windows/doors of the structure, etc.

Concurrently or consecutively, server 110 checks whether the vehicle is standing still or moving into or away from the field of view of image capturing unit 102, as shown at step 714. If the vehicle is not moving, then server 110 sends a notification to the law enforcement officer 116 on his/her law enforcement device 114. The notification includes, but not limited to, location of the vehicle, vehicle identification details, details of the occupant/owner of the vehicle, type of weapon present in the vehicle, etc. If server 110 determines that the vehicle is moving at step 714, then method 700 moves to step 716. At step 716, server 110 employs UAV 118 to follow the vehicle or fleeing person having the weapon and track his/her location. Optionally, server 110 instructs UAV 118 to capture images or live video of the vehicle or fleeing person. Subsequently, server 110 transmits the images or the location received from UAV 118 to law enforcement officer 116 on his/her law enforcement device 114, as shown at step 710. After receiving the notification, law enforcement officer 116 deploys one or more police officers to track down the person carrying the weapon and prevent a mass shooting, knife attack or suicide attack from happening.

Based on the above, it is evident that the presently disclosed subject matter is capable of scanning multiple people and/or vehicles having weapons. Upon scanning, the server recognises the type of weapon(s) carried by them. Further, the server identifies the person by running facial recognition and determines if the person is authorised or unauthorised to carry the weapon. If the person is authorised, then the server does not raise an alert. If the person is unauthorised, then the server records the images, location and generates an alert. The alert includes closing down the windows or doors. Further, the server notifies nearest law enforcement officers of the person carrying the weapon. If the person or vehicle is fleeing from the structure, then the server deploys the UAV to track down until the law enforcement officers capture the person carrying the weapon.

The present subject matter has been described in particular detail with respect to various possible embodiments, and those of skill in the art will appreciate that the subject matter may be practiced in other embodiments. First, the particular naming of the components, capitalization of terms, the attributes, data structures, or any other programming or structural aspect is not mandatory or significant, and the mechanisms that implement the subject matter or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present subject matter in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present subject matter include process steps and instructions described herein in the form of an algorithm. It should be noted that the process steps and instructions of the present subject matter could be embodied in software, firmware, or hardware, and when embodied in software, could be downloaded to reside on and be operated from different platforms used by real-time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. Also, the present subject matter is not described with reference to any particular programming language. It is appreciated that a variety of programming languages may be used to implement the teachings of the present subject matter as described herein, and any references to specific languages are provided for disclosure of enablement and best mode of the present subject matter.

It should be understood that components shown in FIGUREs are provided for illustrative purposes only and should not be construed in a limited sense. A person skilled in the art will appreciate alternate components that may be used to implement the embodiments of the present subject matter and such implementations will be within the scope of the present subject matter.

While preferred embodiments have been described above and illustrated in the accompanying drawings, it will be evident to those skilled in the art that modifications may be made without departing from this subject matter. Such modifications are considered as possible variants included in the scope of the subject matter.

I claim:

1. A system for automatically and remotely identifying a weapon, and tracking and generating an alert in response to the weapon identification comprising:
an image capturing unit installed at a structure, said image capturing unit comprising an image sensor and an infrared sensor;
said infrared sensor comprising optical imaging and sensing components, information processing and communication circuitry, non-volatile memory, and computer instructions for identifying weapons being carried by persons or vehicles in a field of view of said image capturing unit;
said image sensor further comprising circuitry and sensing means for capturing and recording the images of the person and/or a vehicle; and
said image capturing unit further comprising means for notifying law enforcement officers of the person and/or the vehicle having weapons.

2. The system of claim 1, wherein said the image capturing unit connects to an unmanned aerial vehicle (UAV) and automatically and remotely providing commands and data to said UAV to enable said UAV to deploy and track a designated location after the person and/or the vehicle moves away from the field of view of the image capturing unit.

3. The system of claim 2, further comprising circuitry and instructions for automatically and remotely instructing said UAV to track the person and/or the vehicle until the law enforcement officers may capture the person and/or the vehicle.

4. The system of claim 1, further comprising circuitry and instructions for automatically and remotely identifying a weapon within or outside of a structure.

5. The system of claim 1, further comprising circuitry and instructions for automatically and remotely recording images or video of the person or vehicle having the weapon from the moment of detection and notifying law enforcement officers of the danger posed by them.

6. The system of claim 1, further comprising circuitry and instructions for automatically and remotely classifying a sensed weapon as a weapon from the group essentially consisting of a gun, pocket knife, grenade, explosive device, where said image sensor captures and records the images of the person and/or the vehicle.

7. The system of claim 1, further comprising circuitry and instructions for automatically and remotely capturing and tracking the person standing at a place or moving at random speeds for activating recording circuitry upon said system detecting a weapon.

8. The system of claim 1, further comprising circuitry and instructions for automatically and remotely categorizing and communicating a level of threat into (three) different categories depending on an identification of a person possessing the weapons.

9. The system of claim 1, further comprising circuitry and instructions for automatically and remotely controlling said infrared sensor for detecting weapon to be from the group comprising a knife, gun, an explosive weapon, and a grenade, based on temperature differences between the weapon and the background body temperature of the person or vehicle carrying the weapon.

10. The system of claim 1, further comprising circuitry and instructions for automatically and remotely controlling said image capturing unit for capturing images of weapons carried in the body, backpacks, suitcases, clothing, vehicles, and similar location at all times of the day.

11. A method for automatically and remotely identifying a weapon, and tracking and generating an alert in response to the weapon identification, the method comprising the steps of:
operating an image capturing unit installed at a structure, said image capturing unit comprising an image sensor and an infrared sensor;
operating said infrared sensor to control optical imaging and sensing components, information processing and communication circuitry, non-volatile memory, and computer instructions for identifying weapons being carried by persons or vehicles in a field of view of said image capturing unit;
operating said image sensor further using circuitry and sensing means for capturing and recording the images of the person and/or a vehicle; and
operating said image capturing unit to further controlling circuitry and processing instructions for notifying law enforcement officers of the person and/or the vehicle having weapons.

12. The method of claim 11, further comprising the steps of controlling circuitry and processing instructions for said image capturing unit to connect to an unmanned aerial vehicle (UAV) and for automatically and remotely providing commands and data to said UAV to enable said UAV to deploy and track a designated location after the person and/or the vehicle moves away from the field of view of the image capturing unit.

13. The method of claim 12, further comprising the steps of controlling circuitry and processing instructions for automatically and remotely instructing said UAV to track the person and/or the vehicle until the law enforcement officers may capture the person and/or the vehicle.

14. In method of claim 11, further comprising the steps of controlling circuitry and processing instructions for automatically and remotely identifying a weapon within or outside of a structure.

15. In method of claim 11, further comprising the steps of controlling circuitry and processing instructions for automatically and remotely recording images or video of the person or vehicle having the weapon from the moment of detection and notifying law enforcement officers of the danger.

16. The method of claim 11, further comprising the steps of controlling circuitry and processing instructions for automatically and remotely classifying a sensed weapon as a weapon from the group essentially consisting of a gun, pocket knife, grenade, explosive device, where said image sensor captures and records the images of the person and/or the vehicle.

17. The method of claim 11, further comprising the steps of controlling circuitry and processing instructions for automatically and remotely capturing and tracking the persons standing at a place or moving at random speeds for activating recording circuitry upon said system detecting a weapon.

18. The method of claim 11, further comprising the steps of controlling circuitry and processing instructions for automatically and remotely categorizing and communicating a level of threat into (three) different categories depending on an identification of a person possessing the weapons.

19. The method of claim 11, further comprising the steps of controlling circuitry and processing instructions of said infrared sensor for detecting the weapon as from the group comprising a knife, gun, explosive weapon, and a grenade, based on temperature differences between the weapon and the background body temperature of the person or vehicle carrying the weapon.

20. The method of claim 11, further comprising the steps of controlling circuitry and processing instructions for automatically and remotely controlling said image capturing unit for capturing images of weapons carried in the body, backpacks, suitcases, clothing, or vehicles at all times of the day.
